(19) United States
(12) Patent Application Publication
(10) Pub. No.: US 2007/0129988 A1
(43) Pub. Date: Jun. 7, 2007

(54) Apparatus and method for supplementing a data report with a highlighted exception trend

(75) Inventor: James Anthony Church, North Vancouver (CA)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 10/260,062

(22) Filed: Sep. 27, 2002

Related U.S. Application Data
(60) Provisional application No. 60/326,079, filed on Sep. 28, 2001.

(51) Int. Cl. G06F 17/30

(52) U.S. Cl. 705/10

(57) ABSTRACT

A method of processing data includes manipulating a data set to produce initial data results including an individual data value. The data set is compared to a data change function over a period of time to selectively identify trend data. Indicia of the trend data is superimposed on the individual data value so that the information associated with the individual data value representing a relatively short period of time can be understood in the context of a trend over a relatively long period of time.

### BRIEF DESCRIPTION OF THE INVENTION

This invention relates generally to the processing of data to produce data reports. More particularly, this invention relates to a technique for identifying a trend in data that constitutes an exception to a predefined norm and to the incorporation of this information into a data report as an extra dimension of information.

### BACKGROUND OF THE INVENTION

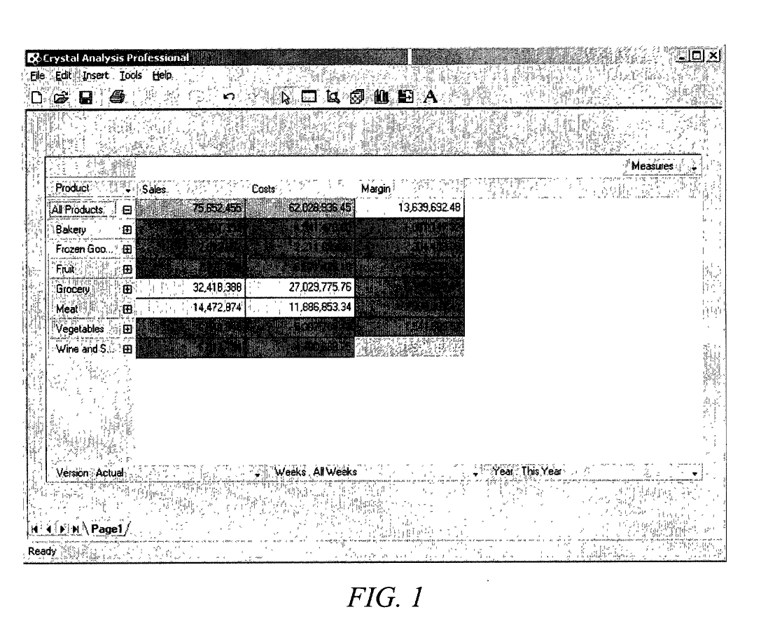

There are many tools used to analyze data. One such tool identifies variances or exceptions in data. The variances or exceptions may be noted in the displayed data through color-coding (e.g., green indicating above expectations and red indicating below expectations). In view of this use of color-coding, this technique is sometimes referred to as “traffic lighting”. A common refinement to this technique is to allow multiple ranges and colors to be defined by the user. FIG. 1 illustrates this prior art technique.

FIG. 1 illustrates the display of data along the dimensions “product” and “measures”. The color-coding, or shading in this instance, is based upon the value in each data cell. That is, a different shade is used based upon whether the data cell value is in range, outside of a first range, outside of a second range, etc. This traffic lighting technique allows an individual to quickly identify aberrations in the underlying data.

While this traffic lighting technique is helpful, it is inherently limited. In particular, the traffic lighting information is limited to alerting an individual with respect to excursions in the underlying displayed data. This prior art technique does not provide information on how the displayed data fits with respect to related data. That is, since the displayed data is a snap shot of data, one does not get a sense of how this snap shot of data relates to previous and subsequent data snap shots. Thus, one cannot quickly identify any underlying trend that the data snap shot might be associated with.

Trend information of this type can be typically gathered by exploring the data manually to identify trends. However, this approach is time-consuming and is subject to human error.

In view of the foregoing, it would be highly desirable to provide an improved technique for analyzing and displaying data so that isolated data values can be appreciated in the context of larger trends.

### SUMMARY OF THE INVENTION

The invention includes a method of processing data. The method includes manipulating a data set to produce initial data results including an individual data value. The data set is compared to a data change function over a period of time to selectively identify trend data. Indicia of the trend data is superimposed on the individual data value so that the information associated with the individual data value representing a relatively short period of time can be understood in the context of a trend over a relatively long period of time.

The invention also includes a computer readable memory to direct a computer to function in a specified manner. A data manipulation module processes a data set and produces a data report. An exception processor includes a trend analysis module to compare a data set to a predetermined data change function over a specified period of time to selectively identify trend data. The exception processor also includes a presentation module to superimpose indicia corresponding to trend data onto data within the data report.

The invention provides a technique for supplementing a data report with highlighted exception trend information. Therefore, while an individual studies a data report covering a given time period, the individual can consider trend information for a period of time longer than the given time period. Thus, the supplemented report provides trend information reflective of data that is not otherwise displayed in the data report.

The invention provides the opportunity to analyze information as percentage magnitude values, thereby simplifying many data analyses. The invention includes a feature to identify trends even when net data changes would not indicate a trend. Advantageously, the invention facilitates a variety of informative output formats to superimpose the trend data on underlying data.

### BRIEF DESCRIPTION OF THE FIGS.

The invention is more fully appreciated in connection with the following detailed description taken in conjunction with the accompanying drawings, in which:

FIG. 1 illustrates a prior art technique for highlighting exception information.

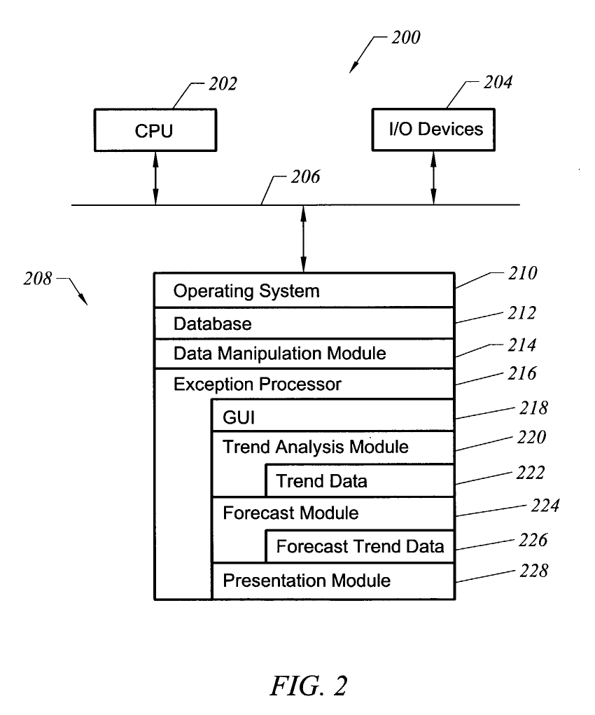

FIG. 2 illustrates a computer configured in accordance with an embodiment of the invention.

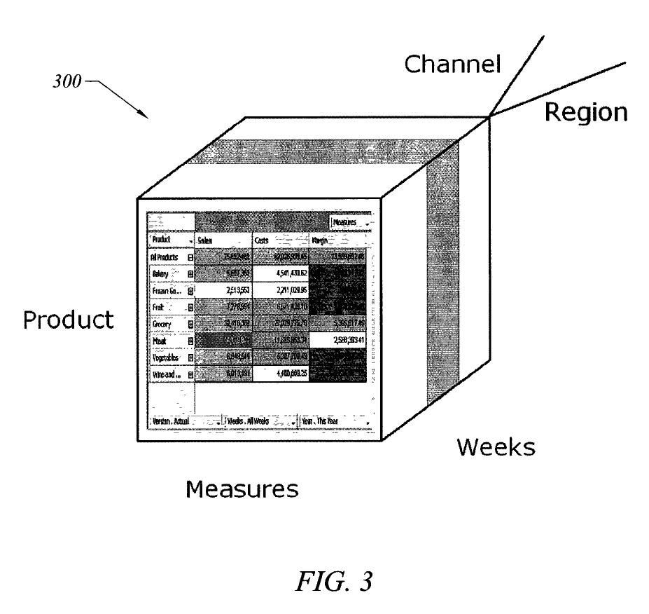

FIG. 3 illustrates a multi-dimensional data cube with information that is processed in accordance with embodiments of the invention.

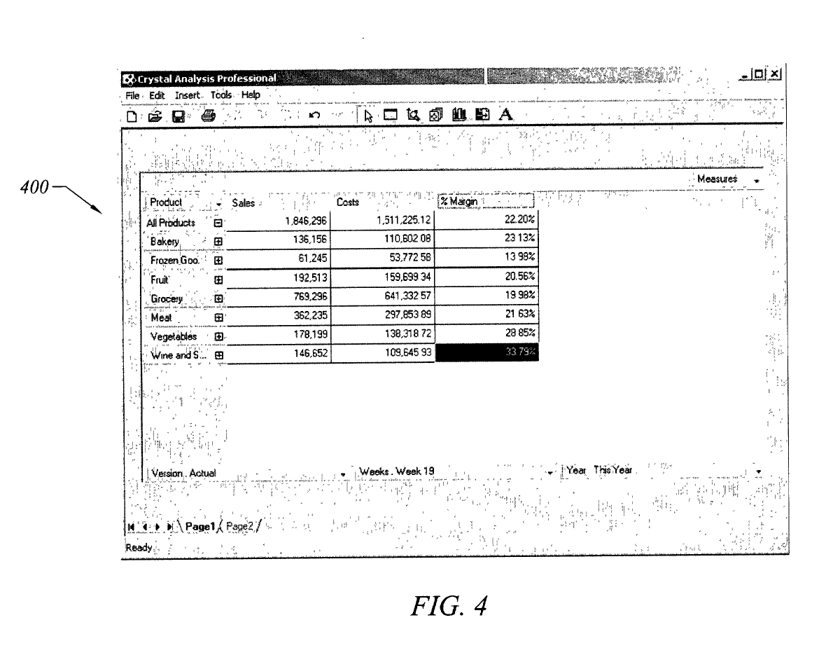

FIG. 4 illustrates percentage margin information calculated in accordance with an embodiment of the invention.

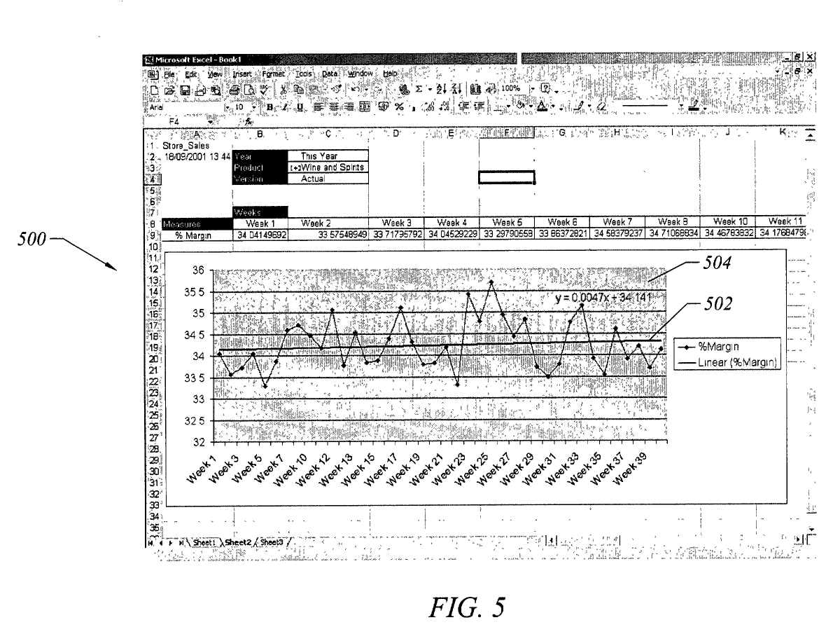

FIG. 5 illustrates plotted percentage margin trend information for a wine and spirits data example.

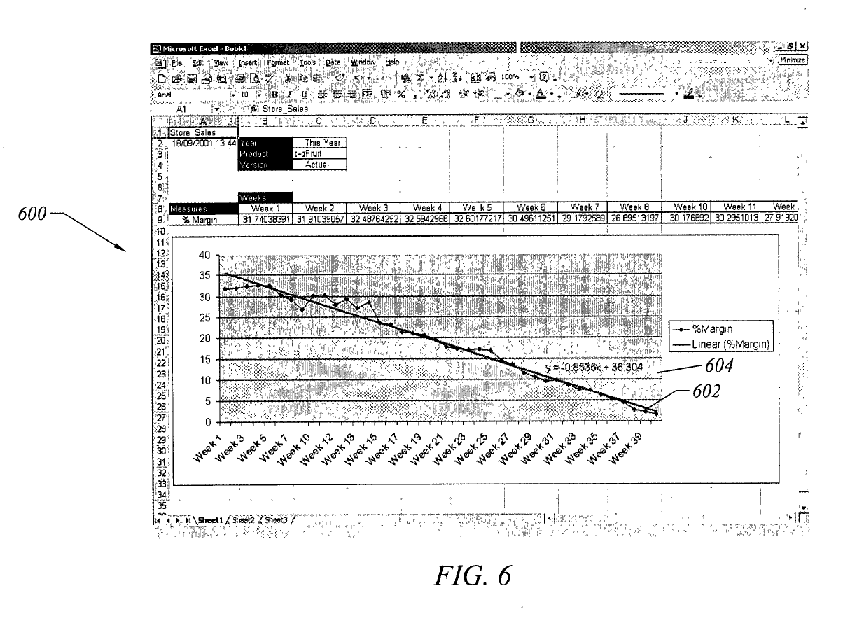

FIG. 6 illustrates plotted percentage margin trend information for a fruit data example.

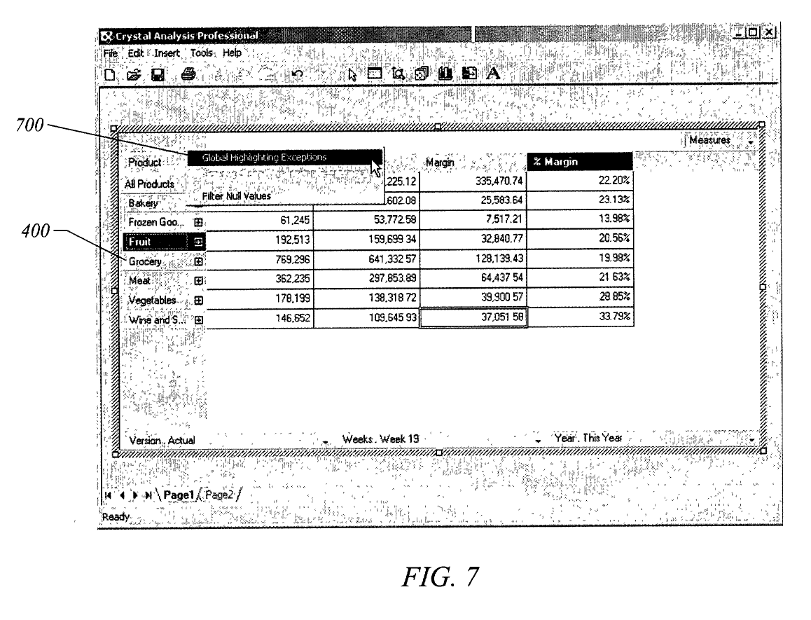

FIG. 7 illustrates a technique for highlighting trend exceptions in a worksheet in accordance with an embodiment of the invention.

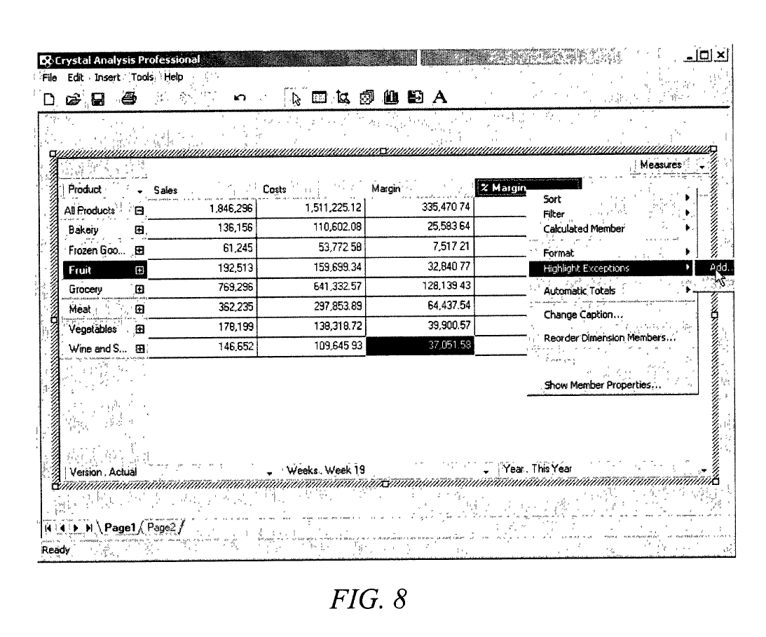

FIG. 8 illustrates a technique for highlighting trend exceptions for single worksheet product in accordance with an embodiment of the invention.

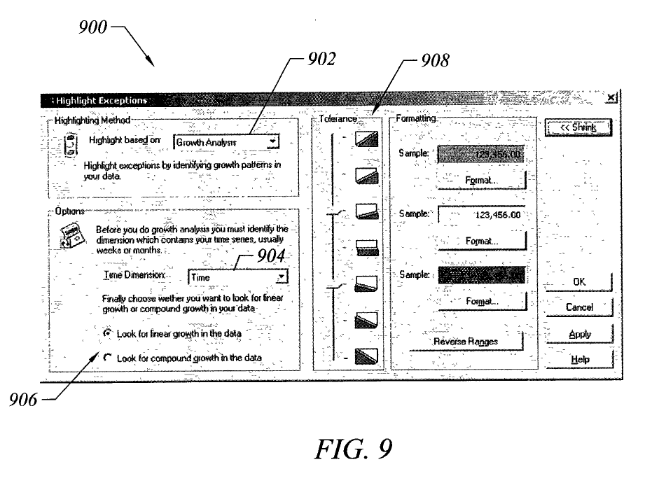

FIG. 9 illustrates a trend exception specification interface that may be utilized in accordance with an embodiment of the invention.

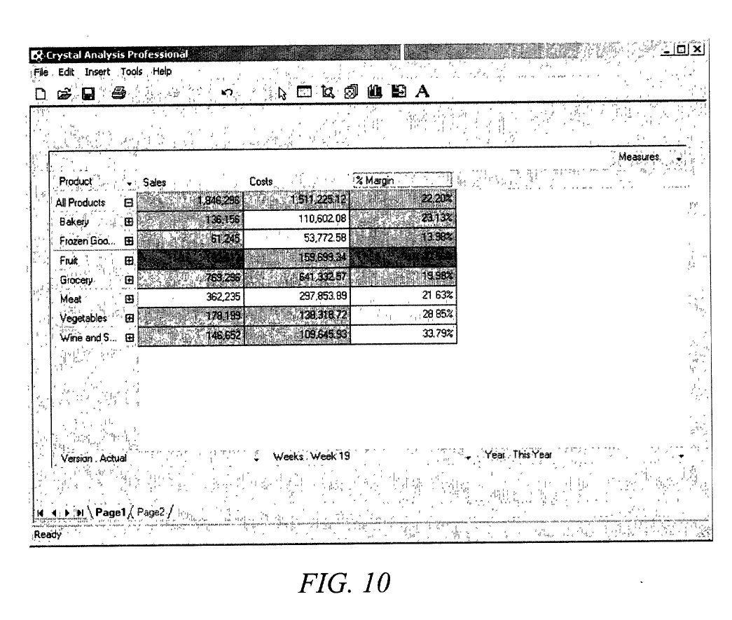

FIG. 10 illustrates trend exception highlighting in accordance with an embodiment of the invention.

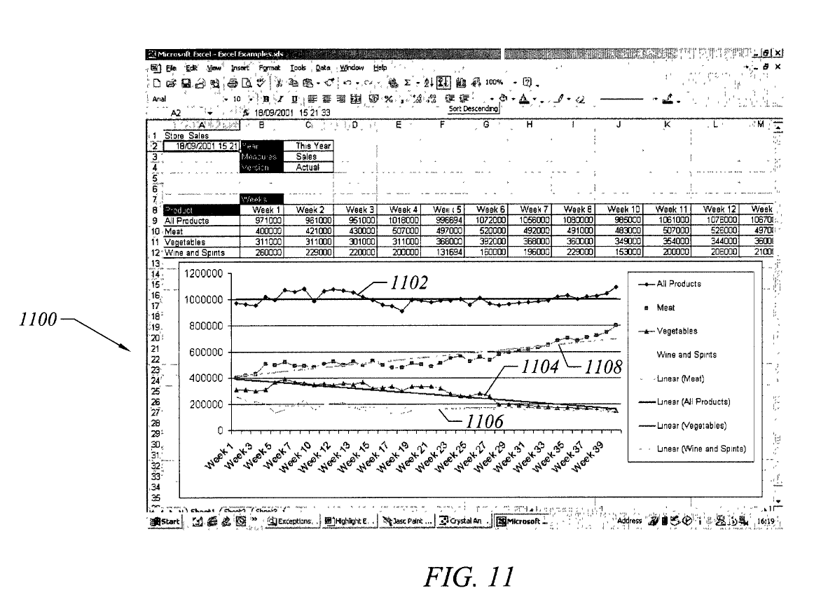

FIG. 11 illustrates data with trend information that is canceled on a net basis and is therefore not reported using prior art techniques.

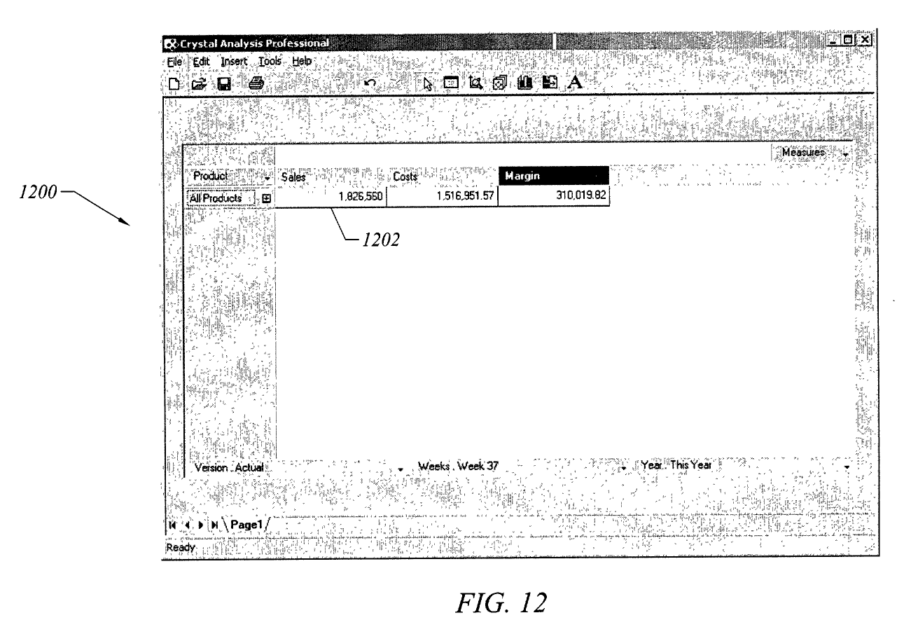

FIG. 12 illustrates reported data that fails to identify trend information.

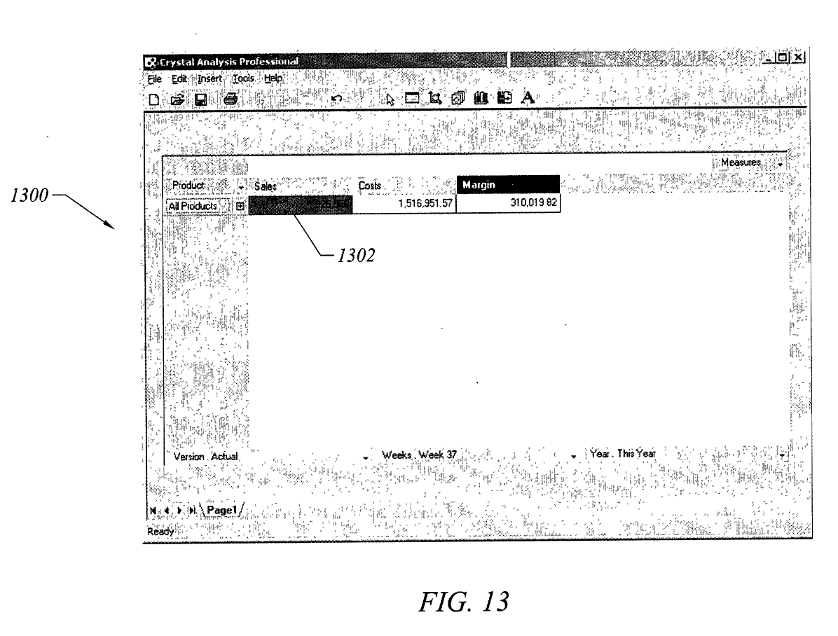

FIG. 13 illustrates a trend report in accordance with an embodiment of the invention.

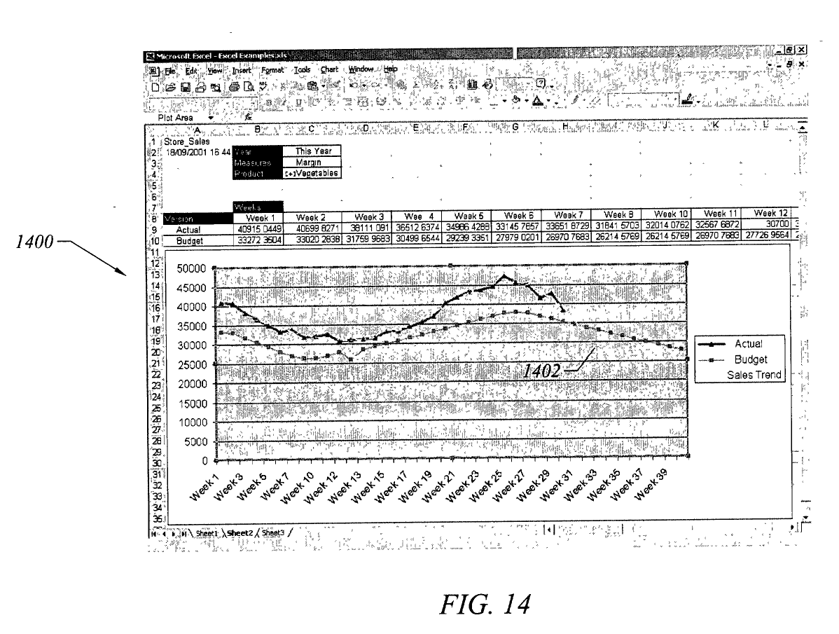

FIG. 14 illustrates a forecasting technique utilizing trend information in accordance with an embodiment of the invention.

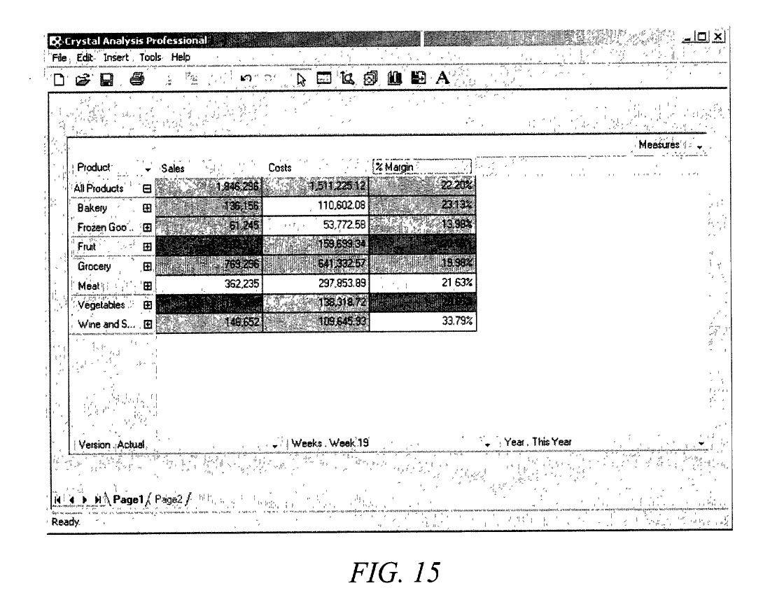

FIG. 15 illustrates forecast based highlighting in accordance with an embodiment of the invention.

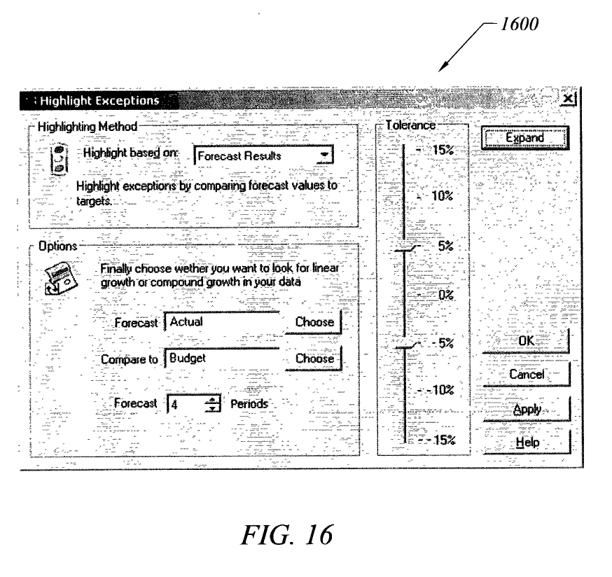

FIG. 16 illustrates a forecast trend-highlighting interface that may be used in accordance with an embodiment of the invention.

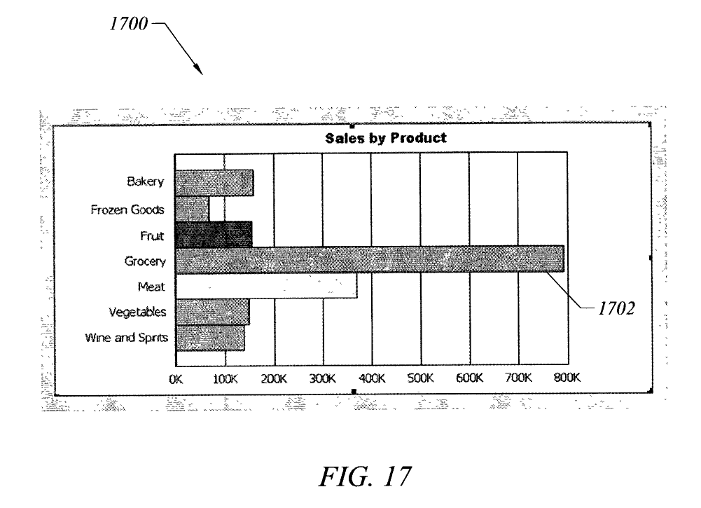

FIG. 17 illustrates advanced data visualization techniques incorporating trend information in accordance with an embodiment of the invention.

Like reference numerals refer to corresponding parts throughout the several views of the drawings.

### DETAILED DESCRIPTION OF THE INVENTION

FIG. 2 illustrates a computer 200 configured in accordance with an embodiment of the invention. The computer 200 includes a central processing unit 202 connected to a set of input/output devices 204 via a bus 206. By way of example, the input/output devices may include a keyboard, mouse, video monitor, flat panel display, printer, and the like.

Also connected to the system bus 206 is a memory 208, which stores a set of executable programs. The memory 208 may be primary and/or secondary memory. By way of example, the memory 208 may store an operating system 210 and a database 212. The hardware and software components of FIG. 2 discussed up to this point are well known in the art. The invention is directed toward the remaining executable programs that are stored in memory 208.

Memory 208 stores a data manipulation module 214. The data manipulation module 214 is used to produce data reports using known techniques. However, the data manipulation module 214 is configured to operate with an exception processor 216. In particular, the exception processor 216 identifies trend information and overlays indicia of that trend information into a data report produced by the data manipulation module 214.

In one embodiment of the invention, the exception processor 216 includes a graphical user interface 218. The graphical user interface 218 includes executable code to present a graphic interface to receive instructions with respect to trend analyses that should be performed on data.

The exception processor 216 also includes a trend analysis module 220. The trend analysis module 220 identifies trend data 222 surrounding a particular data entry appearing in a data report. The nature of the trend analysis is specified through the graphical user interface 218, as demonstrated below.

The exception processor 216 also includes a forecast module 224. The forecast module 224 is used to generate forecasts of trends, which constitute forecast trend data 226. The forecast trend data 226 is used to provide an additional form of trend highlighting, as discussed below.

Finally, the exception processor 216 includes a presentation module 228. The presentation module 228 coordinates the display of analyzed data. For example, the presentation module 228 presents individual data within a data report and superimposes indicia (e.g., a shading or a color) corresponding to trend data associated with the individual data, as shown below.

The features of the invention are more fully appreciated in connection with some specific examples. FIG. 3 illustrates an Online Analytic Processing (OLAP) cube 300 for analyzing four dimensions of information. The invention can be used in connection with OLAP cubes, relational databases, and other aggregated forms of data.

FIG. 4 illustrates a report 400 with “Sales”, “Costs”, and “% Margin” information for the underlying data within cube 300. The “% Margin” entry is a useful way of displaying information on a relative basis and is therefore used in several examples provided herein. This view shows a snapshot of data at a point in time. However, the view gives no context for this snapshot. The tabular form of report 400 does not provide information on trends associated with the data in the report.

FIG. 5 illustrates the same data in the form of a plot 500. More particularly, the plot 500 illustrates data for “Wine and Spirits”, the final entry in the report 400 of FIG. 4. The data manipulation module 214 may be used to show the trend for % margin for Wine and Spirits. The data manipulation module 214 also plots a linear regression line 502. The slope equation 504 for the linear regression line is shown in the plot 500. The information of FIG. 5 illustrates that the margin is experiencing a slight increase over time. This is indicated visually by the line, but also by the gradient value 0.0047.

A similar analysis for the “Fruit” product group of FIG. 4 shows a significant decline in margin, as illustrated by plot 600 of FIG. 6. The downward linear regression line 602 and the negative slope of the slope equation 604 illustrate this decline in margin.

The plotted data of FIGS. 5 and 6 illustrates interesting trend data that is not reflected in any way in the tabular plot of FIG. 4. Therefore, important trend information is not relayed to the individual observing the tabular report of FIG. 4.

The invention is directed toward integrating this trend information into the more general information presented to an end user. The exception processor 216 coordinates this effort. In one embodiment, the graphical user interface 218 is used to generate a window that may be used to invoke trend information. FIG. 7 corresponds to FIG. 4, but the user has selected (e.g., right clicked) the work sheet 400, causing window 700 to appear. Window 700 provides a global highlight exception option. Alternately, the user may select a single entry, for example “Fruit”, to secure trend data in connection with that entry, as shown in FIG. 8.

FIG. 9 illustrates an exception dialog interface 900 that may be used in accordance with an embodiment of the invention. In general, the dialog interface 900 solicits information for the trend analysis module 220. In particular, the dialog interface 900 solicits information with respect to comparing underlying data with a predetermined data change function over a specified period of time.

In the example of FIG. 9, the interface 900 includes a window 902 to specify different highlight options. FIG. 9 illustrates a “Growth Analysis” highlight operation in window 902. Window 904 allows one to specify a period of time over which the analysis is performed. Naturally, the analysis is performed over a time period longer than the time period associated with the displayed data. The interface 900 also includes radio buttons 906 to select different data patterns. By way of example, one radio button allows for the selection of linear growth, while another radio button allows for the selection of compound growth. A slider 908 allows one to set tolerance values for the analysis.

The trend analysis module 220 performs an analysis based upon the information received at the dialog interface 900. By way of example, the trend analysis module 220 uses executable code to perform a regression analysis and generate a regression line slope equation. This type of information, as shown in FIGS. 5 and 6, provides a different perspective on underlying data values. This information or corresponding indicia may then be superimposed on individual data values. For example, FIG. 10 illustrates the tabular report of FIG. 4 coded with indicia of trend data. That is, different shade values are used to reflect different types of trends associated with the data values. For example, the “Fruit” entry now has dark shading, indicating a problem over time. Reviewing the report of FIG. 4 does not reflect this problem since that report is a snapshot of data. The corresponding report of FIG. 10 incorporates information over a longer period of time and therefore provides perspective to the values appearing in the report. Observe that this perspective is achieved by superimposing indicia of the trend data over the individual values. These indicia introduce additional dimensions of information, without explicitly displaying that information.

Preferably, the trend analysis module 220 includes a feature that allows it to identify trends in information, even when a countervailing trend of information produces a net result that suggests that no trend exists. FIG. 11 illustrates a plot 1100 with an “All products” line 1102 reflecting flat growth. This line masks the fact that there are declining revenues for the “Vegetables” as shown with line 1104 and for “Wine & Spirits” as shown with line 1106. These declining revenues are being canceled out by strong growth for “Meat” as shown with line 1108.

FIG. 12 illustrates tabular data 1200 including a cell 1202 with shading that indicates that there is no problem. Thus, the invention can mask certain trend data and simply report a net trend of no problem. Alternately, the invention can identify trend data and reflect that data in the report even when the cumulative trend represents no problem. This option is shown in FIG. 13, where tabular data 1300 includes a cell 1302 with shading that indicates there is a troublesome trend underlying the data value.

FIG. 2 illustrates that the exception processor 216 may include a forecast module 224. The forecast module 224 is used to forecast data based upon historical trends and thereby produce forecast trend data. In accordance with the invention, the forecast trend data can then be used to highlight poor forecast performance.

FIG. 14 illustrates a plot 1400 of actual and budget sales for the “Vegetables” product group for weeks 1 through 30. Using the forecast module 224, a curve is fit to the actual data and is used to forecast the next 4 weeks to week 34, as shown with line 1402. FIG. 14 illustrates that the forecast sales will dip below budget between seek 31 and week 32. This fact is used by the presentation module 228 to superimpose indicia of the forecast trend data into a data report, such as shown in FIG. 15. In particular, FIG. 15 illustrates that both “Fruit” and “Vegetables” are shaded in such a manner as to indicate that they will sell under budget in the future.

FIG. 16 illustrates an interface 1600 to initiate this forecast-based highlighting option. This exemplary interface 1600 allows the user to choose which dimension members to forecast and compare, and what tolerances should be applied to define an exception. Forecasts are performed along a time dimension previously defined in the data manipulation module 214.

The examples up to this point relate to a tabular data output format. Those skilled in the art will appreciate that the techniques of the invention can be applied to many different data formats. FIG. 17 illustrates an example of incorporating trend data into a bar graph 1700, which in this context is referred to as a vector bar graph. Each vector bar 1702 includes two dimensions of information. The length of the bar, which represents a magnitude value, constitutes the first dimension of information. The shading of the bar, which represents trend data, constitutes the second dimension of information. The supplementing of magnitude data with trend data as disclosed is an important improvement over known data representation techniques. Naturally, this technique can be further extended to other visualization paradigms, including maps, pie charts, scatter plots, and the like.

The foregoing description, for purposes of explanation, used specific nomenclature to provide a through understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, the thereby enable other skilled in the art to best utilize the invention and various embodiments with various modifications as are suited to the particular use contemplated. It is intended that the following claims and their equivalents define the scope of the invention.

1. A computer readable memory to direct a computer to function in a specified manner, comprising:
a data manipulation module to process a data set and produce a data report; and
an exception processor including
a trend analysis module to compare said data set to a predetermined data change function over a specified period of time to selectively identify trend data, and
a presentation module to superimpose indicia corresponding to trend data onto data within said data report.

2. The computer readable memory of claim 1 wherein said data is gathered from a first time period and said trend data is gathered from said specified period of time, which is longer than said first time period.

3. The computer readable memory of claim 1 wherein said trend analysis module identifies when data in said data set is outside a predetermined value for said specified period of time.

4. The computer readable memory of claim 1 wherein said trend analysis module produces said trend data even when a first trend in said data set is offset by a second trend in said data so as to minimize cumulative trend data.

5. The computer readable memory of claim 1 wherein said trend analysis module produces trend data in the form of percentage magnitude values.

6. The computer readable memory of claim 1 wherein said trend analysis module utilizes a linear trend data change function.

7. The computer readable memory of claim 1 wherein said trend analysis module utilizes a compound trend data change function.

8. The computer readable memory of claim 1 further comprising a graphical user interface to specify said predetermined data change function and said specified period of time.

9. The computer readable memory of claim 1 wherein said presentation module produces a vector bar with the length of said vector bar corresponding to a magnitude value for said data and the shading of said vector bar providing indicia of said trend data.

10. The computer readable memory of claim 1 further comprising a forecast module to produce forecast trend data, said presentation module superimposing indicia corresponding to said forecast trend data onto said data within said data report.

11. A method of processing data, comprising:
manipulating a data set to produce initial data results including an individual data value;
comparing said data set to predetermined criteria to selectively identify trend data; and
superimposing indicia of said trend data onto said individual data value.

12. The method of claim 11 wherein comparing includes comparing said data set to predetermined criteria including a data change function and a period of time.

13. The method of claim 11 wherein said manipulating produces said individual data value corresponding to a first time period and said comparing selectively produces said trend data over a period of time longer than said first time period.

14. The method of claim 11 wherein said comparing identifies when data in said data set is outside a predetermined value for a predetermined period of time.

15. The method of claim 11 wherein said comparing identifies said trend data even when a first trend in said data set is offset by a second trend in said data set so as to minimize cumulative trend data.

16. The method of claim 11 wherein said comparing includes producing trend data in the form of percentage magnitude values.

17. The method of claim 11 wherein said comparing includes comparing said data set to a linear trend data change function.

18. The method of claim 11 wherein said comparing includes comparing said data set to a compound trend data change function.

19. The method of claim 1 1 further comprising receiving said predetermined criteria from a graphical user interface.

20. The method of claim 11 further comprising displaying a vector bar with the length of said vector bar corresponding to a magnitude value for said data and the shading of said vector bar providing indicia of said trend data.

21. The method of claim 11 further comprising:
producing forecast trend data from said data set; and
superimposing indicia of said trend data onto an individual data value of said data set.
